(19) United States
(12) Patent Application Publication
(10) Pub. No.: US 2014/0376751 A1
(43) Pub. Date: Dec. 25, 2014

(54) MOVING MAGNET TRANSDUCER

(71) Applicant: Jetvox Acoustic Corp., Taoyuan City (TW)

(72) Inventor: To-Teng HUANG, Taoyuan City (TW)

(73) Assignee: Jetvox Acoustic Corp., Taoyuan City (TW)

(21) Appl. No.: 13/962,416

(22) Filed: Aug. 8, 2013

(30) Foreign Application Priority Data
Jun. 20, 2013 (TW) 102211597

(51) Int. Cl. H04R 15/00

(52) U.S. Cl. CPC H04R 15/00
USPC 381/162

(57) ABSTRACT

A moving magnet transducer includes a frame body, a coil, a damping member, a permanent magnet and a vibrating diaphragm. The coil is received in the frame body. The coil is ring shaped, and a central through hole is axially passing through the coil. The damping member is securely assembled in the frame body and disposed above the coil. The permanent magnet is pillar shaped. One end of the permanent magnet is securely assembled to the damping member, and the other end of the permanent magnet is extended into the central through hole without touching the coil. The vibrating diaphragm is securely assembled in the frame body and includes a central vibrating portion. The central vibrating portion is securely assembled to the permanent magnet.

### CROSS-REFERENCES TO RELATED APPLICATIONS

This non-provisional application claims priority under 35 U.S.C. §119(a) on Patent Application No. 102211597 filed in Taiwan, R.O.C. on 2013, Jun. 20, the entire contents of which are hereby incorporated by reference.

### BACKGROUND

1. Technical Field

The disclosure relates to a moving magnet transducer, and particularly relates to a micro-sized moving magnet transducer which is applied in an earphone.

2. Related Art

As shown in FIG. 1, a conventional moving coil earphone A includes an earphone casing A10, a signal cable A1, a vibrating diaphragm A2, a permanent magnet A3, a voice coil A4, a magnet conducting member AS and a yoke A6. The signal cable A1, the vibrating diaphragm A2, the permanent magnet A3, the voice coil A4, the magnet conducting member AS and the yoke A6 are assembled in the earphone casing A10. The voice coil A4 is assembled on the vibrating diaphragm A2 and encloses a periphery of the permanent magnet A3. A radial gap is defined between the voice coil A4 and the magnet conducting member A5. The permanent magnet A3 is sandwiched between the magnet conducting member AS and the yoke A6.

The signal cable A1 is electrically connected to the voice coil A4. When an acoustic signal is inputted to the voice coil A4 via the signal cable A1, the voice coil A4 generates a magnet field via electromagnetic effect firstly, and then the magnet filed is interacted with the magnet conducting member A5 via magnetic forces so as to drive the vibrating diaphragm A2 to vibrate, so that the acoustic signal is converted to an acoustic wave for output.

In order to convert the acoustic signal to the acoustic wave, the voice coil A4 must be electrically connected with a circuit board (not shown), to convert the acoustic signal into a current signal firstly for inputting to the voice coil A4, and then the voice coil A4 is interacted with the magnet conducting member A5 so as to drive the vibrating diaphragm A2 which is connected with the voice coil A4 to vibrate for outputting the acoustic wave. Therefore, the voice coil A4 must be assembled on the vibrating diaphragm A2 firstly and must be further electrically connected to the circuit board in the earphone casing A10, so that the assembling of the conventional moving coil earphone A is quite difficult. Additionally, after vibrating for a long time, the wires connected between the voice coil A4 and the circuit board are possibly broken or detached from the voice coil A4 or the circuit board.

### SUMMARY

In view of this, the disclosure proposes a moving magnet transducer including a frame body, a coil, a damping member, a permanent magnet and a vibrating diaphragm. The coil is received in the frame body. The coil is ring shaped, and a central through hole is axially passing through the coil. The damping member is securely assembled in the frame body and disposed above the coil. The permanent magnet is pillar shaped. One end of the permanent magnet is securely assembled to the damping member, and the other end of the permanent magnet is extended into the central through hole without touching the coil. The vibrating diaphragm is securely assembled in the frame body and includes a central vibrating portion. The central vibrating portion is securely assembled to the permanent magnet.

Based on the above, when electric current are passing through the coil so as to induce a change of the magnetic field, the permanent magnet in the coil moves in corresponding to the magnetic field of the coil, and drives the vibrating diaphragm to vibrate so as to convert the acoustic signal to voice for output. Since the magnetic field is generated via the movement of the permanent magnet rather the coil, the electrical connection between the coil and the circuit board does not be damaged upon long time operation. Additionally, since the components of the moving magnet transducer have different diameters, the components of the moving magnet transducer can be aligned along the central axis by enclosing one with another, so that the frame body, the coil and the permanent magnet are assembled along a central axis; namely, the frame body, the coil and the permanent magnet is assembled coaxially, so that the assembling of the disclosure becomes quite easy and the time for manufacturing the disclosure can be reduced. In addition, the moving magnet transducer can be further miniaturized.

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only, and thus are not limitative of the disclosure, and wherein:

FIG. 1 is a cross-sectional view of a conventional moving coil earphone;

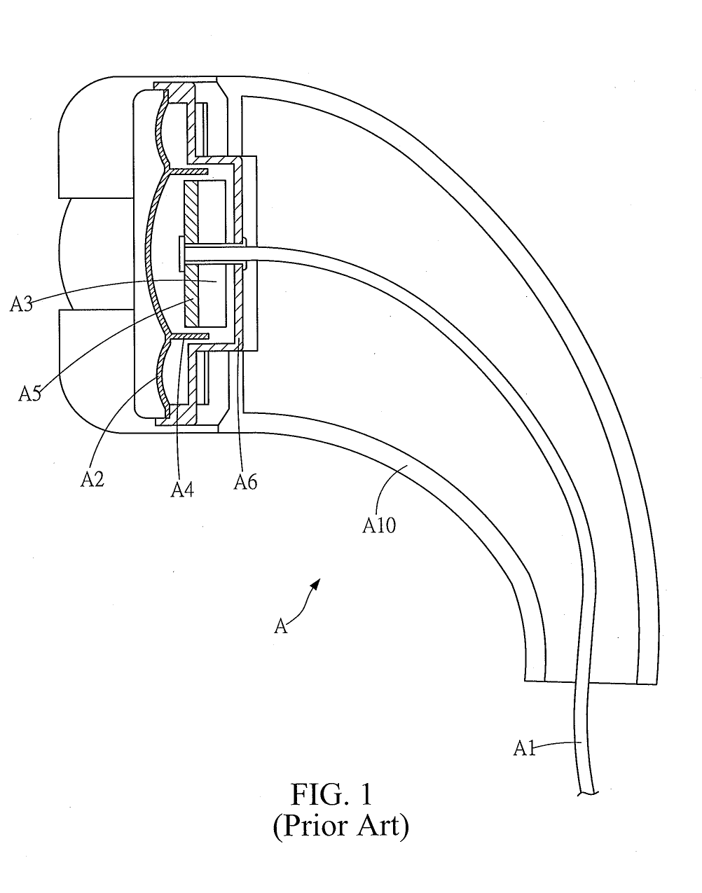

FIG. 2 is an exploded view of a moving magnet transducer of a first embodiment of the disclosure;

FIG. 3 is cross-sectional view of the moving magnet transducer of the first embodiment of the disclosure;

FIG. 4 is a cross-sectional view of an earphone assembled with the moving magnet transducer of the first embodiment of the disclosure; and

FIG. 5 is perspective view for showing a damping member of a moving magnet transducer of a second embodiment of the disclosure.

### DETAILED DESCRIPTION

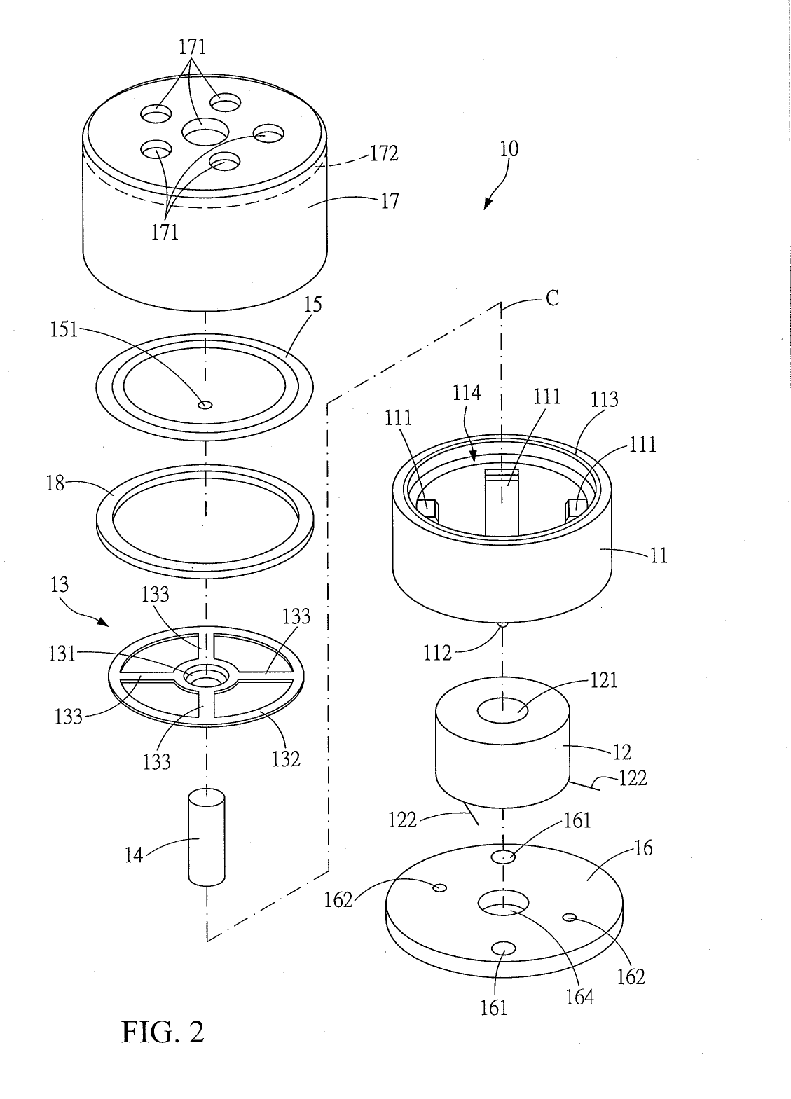

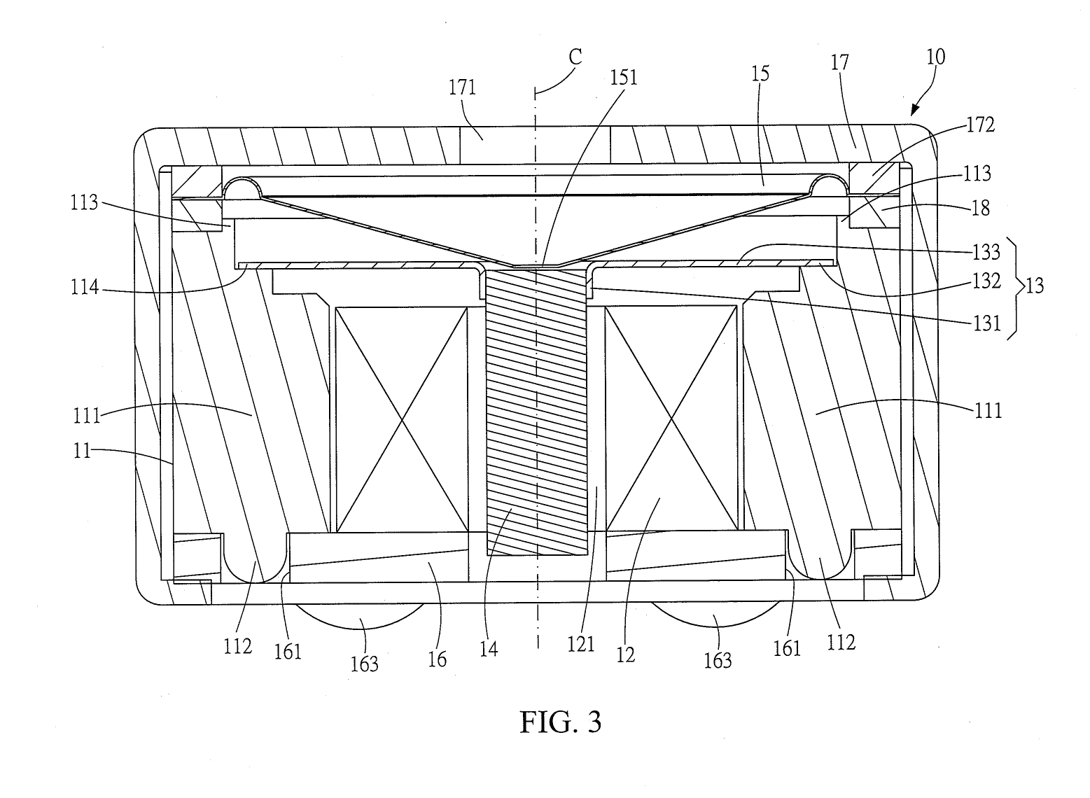

FIG. 2 and FIG. 3 show a moving magnet transducer 10 of a first embodiment of the disclosure, which are respectively an exploded view and a cross-sectional view of the moving magnet transducer 10 of the first embodiment of the disclosure. The moving magnet transducer 10 of the first embodiment of the disclosure includes a frame body 11, a coil 12, a damping member 13, a permanent magnet 14, a vibrating diaphragm 15, a circuit board 16, a casing 17 and a fastening ring 18.

The coil 12 is ring shaped and a central through hole 121 is axially passing through the coil 12. The coil 12 is disposed on a first surface of the circuit board 16 and electrically connected to the circuit board 16. As shown in FIGS. 2-3, two via holes 162 are passing through the circuit board 16. Two ends of the wire 122 winded on the coil 12 are passing through the two via holes 162 and welded on a second surface of the circuit board 16, so that two welding points 163 are formed on the circuit board 16 in which the second surface is opposite to the first surface. That is to say, two wires 122 of the coil 12 are passing through the two via holes 162 respectively and welded on the second surface of the circuit board 16. In other implementation aspects, the electric circuit for connecting with the coil 12 is disposed on the first surface of the circuit board 16. Therefore, the two ends of the wires 122 are directly welded on the circuit board 16, and the via holes 162 can be omitted.

The frame body 11 is sleeved on the coil 12 and disposed on the circuit board 16. In this embodiment, the frame body 11 is hollow cylinder shaped and is coaxially assembled with the coil 12, but embodiments of the disclosure are not limited thereto. In order to enforce the structural strength of the frame body 11, a plurality of enforcing ribs 111 is radially disposed in an inner surface of the frame body 11. The coil 12 is received in the frame body 11 without touching the frame body 11.

In this embodiment, the frame body 11 is assembled on the circuit board 16 via means of buckling and the details are described as following. A plurality of positioning members 112 is extruded from the frame body 11, and a plurality of positioning holes 161 is disposed on the circuit board 16 and corresponds to the positioning members 112. As shown in FIG. 3, in this embodiment, two positioning members 112 are extruded on the frame body 11, and two positioning holes 161 are disposed on the circuit board 16, so that the two positioning members 112 of the frame body 11 are respectively buckled with the two positioning holes 161 of the circuit board 16 so as to securely assembled the frame body 11 on the circuit board 16. In other implementation aspects, the frame body 11 is disposed on the circuit board 16 via means of adhering, but embodiments of the disclosure are not limited thereto.

The damping member 13 is securely assembled in the frame body 11 and is disposed above the coil 12. The permanent magnet 14 is pillar shaped. One end of the permanent magnet 14 is securely assembled to the damping member 13, and the other end of the permanent magnet 14 is extended into the central through hole 121 without touching the coil 12, as shown in FIG. 3. Please refer to FIG. 2, in which the damping member 13 includes an axial tube 131, an outer ring 132 and a plurality of radial connecting members 133. In this embodiment, the damping member 13 includes four radial connecting members 133. The four radial connecting members 133 are respectively connected to the outer ring 132 and the axial tube 131 with an axle center of the axial tube 131 being positioned at an axle center of the outer ring 132. In this embodiment, the axial tube 131, the outer ring 132 and the four radial connecting members 133 are integrated as a whole via metal stamping arts or so forth so as to form the damping member 13 with a proper appearance. Further, the four radial connecting members 133 are aligned so as to form a cross shaped structure.

In the frame body 11, an annular supporting portion 114 is disposed on the enforcing ribs 112, and the outer ring 132 of the damping member 13 is securely assembled on the annular supporting portion 114. In this embodiment, the damping member 13 is adhered on the annular supporting portion 114 by UV glues, but embodiments of the disclosure are not limited thereto.

One end of the permanent magnet 14 is securely assembled in the axial tube 131 of the damping member 13 by UV glues, so that an axle center of the permanent magnet 14 is coaxial with the axle center of the axial tube 131. Based on this, the frame body 11, the coil 12 and the permanent magnet 14 are assembled along a central axis C; namely, the frame body 11, the coil 12 and the permanent magnet 14 is assembled coaxially, so that the assembling of the disclosure becomes quite easy and the time for manufacturing the disclosure can be reduced. Furthermore, the damping member 13 is designated as a round circle shaped structure so as to be assembled properly, so that the axle center of the permanent magnet 14 can be positioned at the central axis C. Further, as shown in FIG. 3, a through hole 164 is disposed on the circuit board 16 and corresponding to the permanent magnet 14, so that when the permanent magnet 14 moves back and forth, the permanent magnet 14 does not contact with the circuit board 16.

The vibrating diaphragm 15 is securely assembled in the frame body 11 and includes a central vibrating portion 151. The central vibrating portion 151 is securely connected to the permanent magnet 14. In this embodiment, the fastening ring 18 is securely assembled on a periphery of the vibrating diaphragm 15 and is assembled on the frame body 11. The fastening ring 18 can be securely assembled on the vibrating diaphragm 15 by UV glues, but embodiments of the disclosure are not limited thereto, the fastening ring 18 can be securely assembled on the vibrating diaphragm 15 by other methods. Similarly, the central vibrating portion 151 can be fastened on the permanent magnet 14 by UV glues. As shown in FIG. 2, a positioning ring 113 is extruded from an upper portion of the frame body 11; and as shown in FIG. 3, an inner diameter of the fastening ring 18 is equal to an outer diameter of the positioning ring 113, so that the fastening ring 18 can be assembled on the frame body 11 properly.

As shown in FIGS. 2-3, the casing 17 encloses the frame body 11 and the circuit board 16. The casing 17 has at least one voice output hole 171 disposed thereon. The voice generated by the vibration of the vibrating diaphragm 15 is transmitted out of the casing 17 via the voice output hole 171. In this embodiment, the casing 17 has six voice output holes 171 in which the six voice output holes 171 are aligned as a pattern like a plum blossom, but embodiments of the disclosure are not limited thereto.

When all the components are sequentially assembled in the frame body 11, the casing 17 further encloses out of the frame body 11 and the circuit board 16, and a curving process is applied to trim the edge of the casing 17, so that the frame body 11 and the circuit board 16 are received in the casing 17, as shown in FIG. 3. Additionally, the casing 17 has a pressing ring 172 assembled therein. The pressing ring 172 is correspondingly disposed on the periphery of the vibrating diaphragm 15. When the casing 17 encloses the frame body 11, the pressing ring 172 correspondingly presses on the periphery of the vibrating diaphragm 15. Consequently, the vibrating diaphragm 15 is sandwiched by the pressing ring 172 and the fastening ring 18, so that the vibrating diaphragm 15 is assembled properly and does not detach from the disclosure easily after long time vibrations.

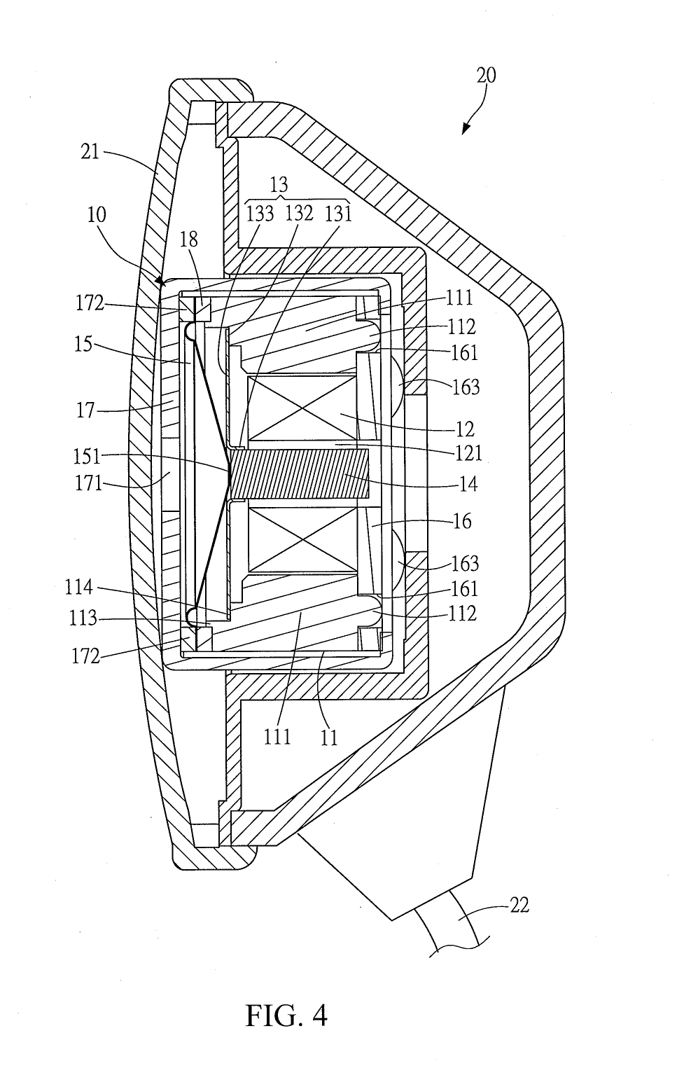

Please refer to FIG. 4, which is a cross-sectional view for showing the moving magnet transducer 10 of the first embodiment of the disclosure applying to an earphone 20. The moving magnet transducer 10 is assembled in a housing 21 of the earphone 20, and a signal cable 22 of the earphone 20 is electrically connected to the circuit board 16. When the acoustic signal is inputted into the circuit board 16 via the signal cable 22, the circuit board 16 transmitted an electrical signal to the coil 12; and then, the coil 12 generates a magnet field via electromagnetic effect, and the permanent magnet 14 disposed in the central through hole 121 of the coil 12 is magnetically interacted with the magnet field. Along with the position of the damping member 13, the permanent magnet 14 is moved back and forth along the central axis C so as to drive the vibrating diaphragm 15 to vibrate and convert the acoustic signal to an acoustic wave for output.

In the moving magnet transducer 10 of the disclosure, most of the components is formed as cylinder or ring shaped so as to be positioned easily upon assembling. Additionally, since the components of the moving magnet transducer 10 have different diameters, the components of the moving magnet transducer 10 can be aligned along the central axis C by enclosing one with another, so that the moving magnet transducer 10 can be further miniaturized. Since the coil 12 is secured on the circuit board 16 and the vibration of the permanent magnet 14 drives the vibration of the vibrating diaphragm 15 for generating acoustic wave, therefore, the electrical connection between the coil 12 and the circuit board 16 does not be damaged upon long time operation; that is to say, the magnetic field is generated via the movement of the permanent magnet 14 rather the coil 12.

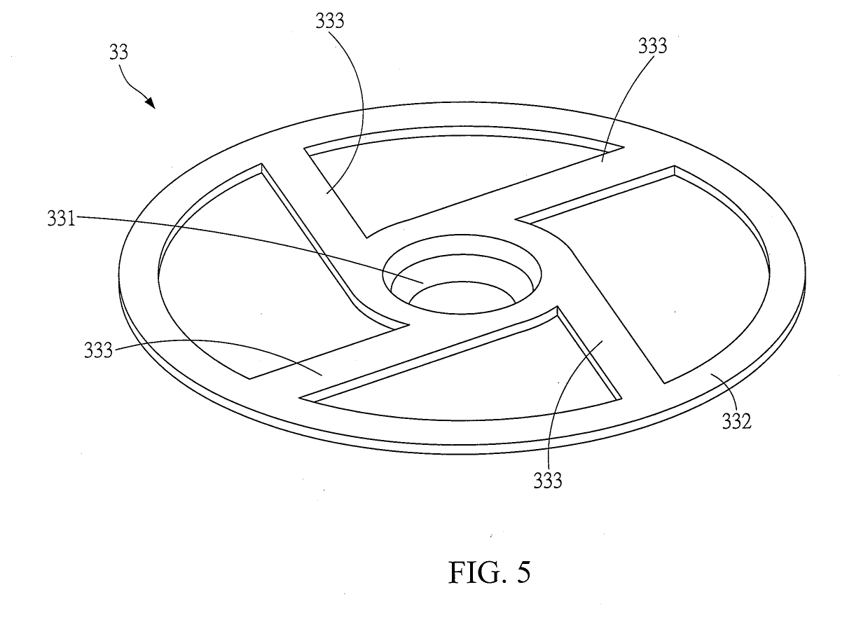

FIG. 5 is a perspective view for showing a damping member 33 of a moving magnet transducer 10 of a second embodiment of the disclosure. The moving magnet transducer 10 of the second embodiment is approximately the same as that of the first embodiment, except that the appearance of the damping member 33. As shown in FIG. 5, the damping member 33 includes an axial tube 331, an outer ring 332 and a plurality of radial connecting members 333. In this embodiment, the damping member 33 includes four radial connecting members 333. The four radial connecting members 333 are respectively connected to the outer ring 332 and the axial tube 331 with an axle center of the axial tube 331 being positioned at an axle center of the outer ring 332.

In this embodiment, the four radial connecting members 333 are aligned radially, and two adjacent radial connecting members 333 are perpendicular with each other; and, one radial connecting member 333 is connected to one end of the axial tube 331 and is approximately corresponding to a center portion of the other radial connecting member 333. The alignments of the radial connecting members 333 of the damping member 33 can be adjusted to provide different damping values for the permanent magnet 14 so as to affect the frequency of the voice outputted. According to this, the damping members 33 with different appearances are selected according to users' requirements.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

1. A moving magnet transducer, comprising:
a frame body;
a coil, received in the frame body, the coil being ring shaped, a central through hole axially passing through the coil;
a damping member, securely assembled in the frame body and disposed above the coil;
a permanent magnet, formed as pillar shaped, one end of the permanent magnet being securely assembled to the damping member, the other end of the permanent magnet being extended into the central through hole without touching the coil; and
a vibrating diaphragm, securely assembled in the frame body, comprising a central vibrating portion securely connected to the permanent magnet.

2. The moving magnet transducer according to claim 1, wherein the damping member comprises an axial tube, one end of the permanent magnet is securely assembled in the axial tube.

3. The moving magnet transducer according to claim 2, wherein the damping member further comprises an outer ring and a plurality of radial connecting members, the radial connecting members are respectively connected to the outer ring and the axial tube.

4. The moving magnet transducer according to claim 3, wherein the axial tube, the outer ring and the radial connecting members are integrated as a whole.

5. The moving magnet transducer according to claim 1, further comprising a circuit board, the frame body is assembled on the circuit board, and the coil is electrically connected to the circuit board.

6. The moving magnet transducer according to claim 5, wherein the circuit board has two via holes passing therethrough, two wires of the coil are passing through the two via holes respectively and welded on the circuit board.

7. The moving magnet transducer according to claim 5, wherein the frame body has a plurality of positioning members extruded therefrom, a plurality of positioning holes is disposed on the circuit board and corresponding to the positioning member.

8. The moving magnet transducer according to claim 5, further comprising a casing enclosing the frame body and the circuit board, the casing has at least one voice output hole.

9. The moving magnet transducer according to claim 8, wherein the casing has a pressing ring assembled therein and correspondingly disposed on a periphery of the vibrating diaphragm.

10. The moving magnet transducer according to claim 6, further comprising a casing enclosing the frame body and the circuit board, the casing has at least one voice output hole.

11. The moving magnet transducer according to claim 10, wherein the casing has a pressing ring assembled therein and correspondingly disposed on a periphery of the vibrating diaphragm.

12. The moving magnet transducer according to claim 7, further comprising a casing enclosing the frame body and the circuit board, the casing has at least one voice output hole.

13. The moving magnet transducer according to claim 12, wherein the casing has a pressing ring assembled therein and correspondingly disposed on a periphery of the vibrating diaphragm.

14. The moving magnet transducer according to claim 1, further comprising a fastening ring securely assembled on a periphery of the vibrating diaphragm and assembled on the frame body.

15. The moving magnet transducer according to claim 1, wherein the frame body, the coil and the permanent magnet is assembled coaxially.
